(19) United States
(12) Patent Application Publication
(10) Pub. No.: US 2026/0125032 A1
(43) Pub. Date: May 7, 2026

(54) BRAKE SYSTEM AND METHOD FOR MANAGING PEDAL DISPLACEMENT SENSOR OF BRAKE SYSTEM

(71) Applicant: HL MANDO CORPORATION, Pyeongtaek-si (KR)

(72) Inventor: Chanhee LEE, Pyeongtaek-si (KR)

(21) Appl. No.: 19/009,044

(22) Filed: Jan. 3, 2025

(30) Foreign Application Priority Data
Nov. 4, 2024 (KR) 10-2024-0154497

(51) Int. Cl. B60T 7/04; B60T 8/171

(52) U.S. Cl. CPC B60T 7/042; B60T 8/171

(57) ABSTRACT

A brake system includes a pedal displacement sensor configured to detect displacement of a brake pedal, a memory configured to store identification information of the pedal displacement sensor, and a controller electrically connected to the pedal displacement sensor and the memory, in which the controller receives identification information of the pedal displacement sensor from the pedal displacement sensor based on the ignition of a vehicle, and determines whether the pedal displacement sensor has been replaced based on comparison of the received identification information and the stored identification information.

### CROSS-REFERENCE TO RELATED APPLICATIONS

This application claims the priority of Korean Patent Application No. 10-2024-0154497 filed on November 4, 2024, in the Korean Intellectual Property Office, the disclosure of which is incorporated herein by reference.

### BACKGROUND

### Technical Field

The present disclosure relates to a brake system and a method for managing a pedal displacement sensor of the brake system.

### Description of the Related Art

A brake pedal is a device that controls the braking of a vehicle according to the driver’s will to brake, and when displacement of the brake pedal is detected by a pedal displacement sensor provided on the brake pedal, the corresponding signal is transmitted to a brake system, so that the brake system may use the signal to control the braking of the vehicle.

In brake systems such as an integrated dynamic brake (IDB) and an electro-mechanical brake (EMB), a braking amount is determined based on an output signal of a pedal displacement sensor for the brake pedal, so a displacement amount relative to a zero-point of the pedal displacement sensor is important. In particular, in the case of an external pedal displacement sensor, mounting tolerance may occur, and in order to remove the influence of the mounting tolerance on braking control, a zero-point calibration of the pedal displacement sensor is performed in the end of line (EOL) of vehicle manufacturing.

Meanwhile, when the pedal displacement sensor needs to be replaced due to a failure of the pedal displacement sensor, there is a high possibility that a large mounting tolerance will occur when only the pedal displacement sensor itself is replaced in the related art. Accordingly, a method of replacing the assembly on which the pedal displacement sensor is mounted is being applied in order to minimize the mounting tolerance of the pedal displacement sensor and further increase the ease of tolerance management of the pedal displacement sensor.

In addition, when replacing the assembly on which the pedal displacement sensor is mounted, although the maintenance manual states that the zero-point calibration of the pedal displacement sensor should be performed in principle, there is no way to confirm whether the zero-point calibration of pedal displacement sensor is performed in accordance with the corresponding maintenance manual at an actual maintenance site.

Accordingly, the development of new technologies to detect and manage the replacement of pedal displacement sensors is required.

### BRIEF SUMMARY

According to one aspect of the present disclosure, it is possible to provide a brake system for detecting and managing replacement of a pedal displacement sensor for a brake pedal, and a method for managing a pedal displacement sensor of the brake system.

According to one aspect of the present disclosure, it is possible to provide a brake system capable of detecting replacement of a pedal displacement sensor for a brake pedal and inducing zero-point calibration of the pedal displacement sensor, and a method for managing a pedal displacement sensor of the brake system.

According to one aspect of the present disclosure, it is possible to provide a brake system which can eliminate a tolerance management process of an external pedal displacement sensor and reduce manufacturing costs, and a method for managing a pedal displacement sensor of the brake system.

According to one aspect of the present disclosure, it is possible to provide a brake system which can reduce maintenance costs by replacing only a pedal displacement sensor unit instead of replacing an assembly including a conventional pedal displacement sensor when the pedal displacement sensor fails, and a method for managing a pedal displacement sensor of the brake system.

A brake system according to one aspect of the present disclosure includes: a pedal displacement sensor configured to detect displacement of a brake pedal; a memory configured to store identification information of the pedal displacement sensor; and a controller electrically connected to the pedal displacement sensor and the memory, in which the controller is configured to receive identification information of the pedal displacement sensor from the pedal displacement sensor based on the ignition of a vehicle, and determine whether the pedal displacement sensor has been replaced based on comparison of the received identification information and the stored identification information.

The controller may determine that the pedal displacement sensor has been replaced when the received identification information and the stored identification information are different from each other.

The controller may increase a count value when first identification information received from the pedal displacement sensor in a current time period and the stored identification information are different from each other, and determine that the pedal displacement sensor has been replaced based on the increased count value being greater than a pre-specified reference count value.

The controller may compare the first identification information with second identification information received from the pedal displacement sensor in a time period immediately preceding the current time period, based on an increase in the count value, and determine whether the increased count value is greater than the pre-specified reference count value, based on the first identification information and the second identification information being the same.

The controller may set the increased count value to 0 based on the first identification information and the second identification information being different from each other and the increased count value being greater than 1, and receive identification information from the pedal displacement sensor.

The controller may store the received identification information in the memory as the identification information of the pedal displacement sensor, based on the determination that the pedal displacement sensor has been replaced.

The controller may transmit a control signal to a control device of the vehicle so that, based on the determination that the pedal displacement sensor has been replaced, a notification is output to an output device of the vehicle to induce zero-point calibration of the pedal displacement sensor.

The controller may determine that the pedal displacement sensor is not replaced when the received identification information and the identification information stored in the memory are the same.

The controller may receive the identification information of the pedal displacement sensor from the pedal displacement sensor through single edge nibble transmission (SENT) communication.

The controller may receive slow channel data including the identification information of the pedal displacement sensor from the pedal displacement sensor through the SENT communication.

A method for managing a pedal displacement sensor of a brake system according to one aspect of the present disclosure includes: receiving identification information of a pedal displacement sensor from the pedal displacement sensor that detects displacement of a brake pedal of a vehicle based on ignition of the vehicle; and determining whether the pedal displacement sensor has been replaced based on comparison of the received identification information and identification information stored in a memory.

The determining of whether the pedal displacement sensor has been replaced may include determining that the pedal displacement sensor has been replaced when the received identification information and the stored identification information are different from each other.

The determining of whether the pedal displacement sensor has been replaced may include increasing a count value when first identification information received from the pedal displacement sensor in a current time period and the stored identification information are different from each other, and determining that the pedal displacement sensor has been replaced based on the increased count value being greater than a pre-specified reference count value.

The determining of whether the pedal displacement sensor has been replaced may include comparing the first identification information with second identification information received from the pedal displacement sensor in a time period immediately preceding the current time period, based on an increase in the count value, and determining whether the increased count value is greater than the pre-specified reference count value, based on the first identification information and the second identification information being the same.

The determining of whether the pedal displacement sensor has been replaced may include setting the increased count value to 0 based on the first identification information and the second identification information being different from each other and the increased count value being greater than 1, and receiving identification information from the pedal displacement sensor.

The method for managing a pedal displacement sensor of a brake system may further include storing the received identification information in the memory as the identification information of the pedal displacement sensor, based on the determination that the pedal displacement sensor has been replaced.

The method for managing a pedal displacement sensor of a brake system may further include transmitting a control signal to a control device of the vehicle so that, based on the determination that the pedal displacement sensor has been replaced, a notification is output to an output device of the vehicle to induce zero-point calibration of the pedal displacement sensor.

The determining of whether the pedal displacement sensor has been replaced may include determining that the pedal displacement sensor is not replaced when the received identification information and the identification information stored in the memory are the same.

The receiving of the identification information of the pedal displacement sensor may include receiving the identification information of the pedal displacement sensor from the pedal displacement sensor through single edge nibble transmission (SENT) communication.

The receiving of the identification information of the pedal displacement sensor may include receiving slow channel data including the identification information of the pedal displacement sensor from the pedal displacement sensor through the SENT communication.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a block diagram illustrating a portion of a brake system according to one embodiment.

FIG. 2 is a view illustrating the structure of a brake pedal and a pedal displacement sensor according to one embodiment.

FIG. 3 is a flow chart of the operation of the brake system according to one embodiment.

FIG. 4 is a flow chart of the operation of the brake system according to one embodiment.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms 'part,' 'module,' 'member,' and 'block' used in this specification may be embodied as software or hardware, and it is also possible for a plurality of 'parts,' 'modules,' 'members,' and 'blocks' to be embodied as one component, or one 'part,' 'module,' 'member,' and 'block' to include a plurality of components according to embodiments.

Throughout the specification, when a part is referred to as being 'connected' to another part, it includes not only a direct connection but also an indirect connection, and the indirect connection includes connecting through a wireless network.

Also, when it is described that a part 'includes' a component, it means that the part may further include other components, not excluding the other components unless specifically stated otherwise.

Throughout the specification, when a member is described as being 'on' another member, this includes not only a case in which the member is in contact with the other member but also a case in which another member is present between the two members.

The terms first, second, etc. are used to distinguish one component from another component, and the components are not limited by the above-mentioned terms.

The singular forms 'a,' 'an,' and 'the' include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Embodiments of the present disclosure provide a brake system for detecting and managing replacement of a pedal displacement sensor for a brake pedal and a method for managing a pedal displacement sensor of the brake system.

In addition, embodiments of the present disclosure provide a brake system capable of detecting replacement of a pedal displacement sensor for a brake pedal and inducing zero-point calibration of the pedal displacement sensor, and a method for managing a pedal displacement sensor of the brake system.

The operating principle and embodiments of the present disclosure will be described with reference to the attached drawings below.

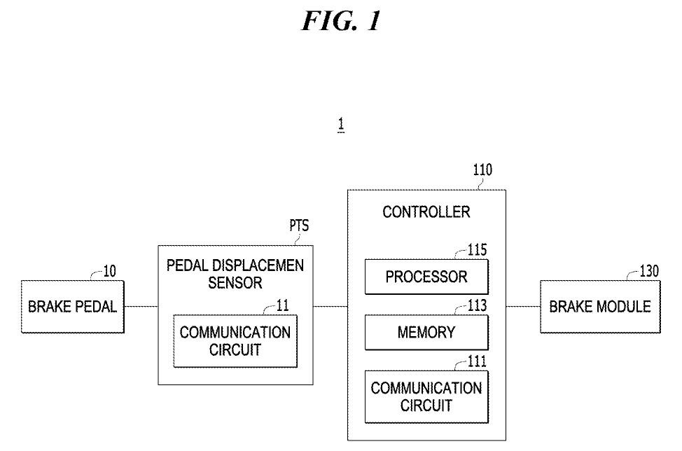

FIG. 1 is a block diagram illustrating a portion of a brake system according to one embodiment.

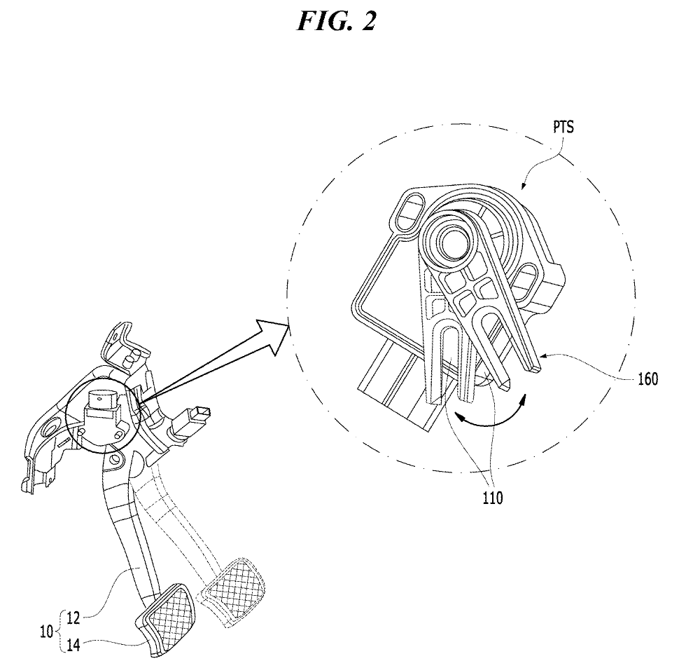

FIG. 2 is a view illustrating the structure of a brake pedal and a pedal displacement sensor according to one embodiment.

Referring to FIG. 1, the brake system 1 may include a brake pedal 10, a pedal displacement sensor PTS, a controller 110, and/or a brake module 130.

The brake pedal 10 may acquire driver input for braking the vehicle.

For example, the brake pedal 10 may be provided at a lower portion of a cabin where the driver may control the brake pedal with his/her feet.

The driver may press the brake pedal 10 as a braking intention to stop the vehicle, and accordingly, the brake pedal 10 may move away from a reference position.

There may be one or more pedal displacement sensors PTS and the pedal displacement sensors may be installed in the brake pedal 10 to output displacement data (or signals) of the brake pedal 10 to the controller 110.

For example, the displacement data may include a movement distance and/or movement speed from a reference position of the brake pedal 10.

For example, the pedal displacement sensor PTS may be an external pedal displacement sensor.

Referring to FIG. 2, the pedal displacement sensor PTS may include a sensor housing 110 and a lever 160.

The sensor housing 110 has an internal space and the pedal displacement sensor PTS may be placed in the internal space.

The pedal displacement sensor PTS may be provided to measure a rotation angle of the lever 160.

The pedal displacement sensor PTS may be coupled to one side surface of a pedal arm 12 of the brake pedal 10. When a driver steps on a pedal pad 14 provided at a distal end portion of the pedal arm 12, the pedal arm 12 pivotally rotates, and at this time, the pedal displacement sensor PTS coupled to the pedal arm 12 may measure the pivot rotation angle of the pedal arm 12 by measuring the rotation angle of the lever 160.

The pedal displacement sensor PTS may output identification information of the pedal displacement sensor PTS to the controller 110. For example, the identification information of the pedal displacement sensor PTS may include an identifier (ID) of the pedal displacement sensor PTS.

The pedal displacement sensor PTS may include a communication circuit 11 and transmit the displacement data of the brake pedal 10 and/or the identification information of the pedal displacement sensor PTS to the controller 110 through the communication circuit 11.

For example, the communication circuit 11 may be configured to perform communicate data through communication such as single edge nibble transmission (SENT).

In the SENT communication, data may be transmitted in the form of packets, and the packets may include slow channel data. The slow channel data may include additional information of the pedal displacement sensor PTS, for example, identification information and/or status information of the pedal displacement sensor PTS.

Meanwhile, in the SENT communication, data may be transmitted to the controller 110 through a Fast channel, and the Fast channel data may include displacement data of the brake pedal 10.

The controller 110 may control the overall brake system 1.

The controller 110 may be electrically connected to the pedal displacement sensor PTS and/or the brake module 130 and may control the pedal displacement sensor PTS and/or the brake module 130.

The controller 110 may receive the displacement data of the brake pedal 10 from the pedal displacement sensor PTS and/or the identification information of the pedal displacement sensor PTS.

The controller 110 may control the brake module 130 based on the displacement data of the brake pedal 10 received from the pedal displacement sensor PTS.

The controller 110 may determine whether the pedal displacement sensor PTS has been replaced based on the identification information of the pedal displacement sensor PTS received from the pedal displacement sensor PTS.

The controller 110 may transmit a control signal to a vehicle control device (not illustrated) so that, based on the determination that the pedal displacement sensor PTS has been replaced, a notification is output to an output device (not illustrated) of the vehicle to induce zero-point calibration of the pedal displacement sensor PTS.

For example, the controller 110 may be electrically connected or communicatively connected to a vehicle control device via a communication circuit 111 to transmit a control signal to the vehicle control device (not illustrated).

When the zero-point calibration is not performed after replacing the pedal displacement sensor PTS, an initial output voltage value of the pedal displacement sensor PTS is set regardless of the actual position of the brake pedal 10.

Accordingly, when a difference occurs between an output voltage value (Output (V)) of the pedal displacement sensor PTS according to the movement of the brake pedal 10 and an actual voltage value and the corresponding data is transmitted to the controller 110, the controller 110 may not correctly recognize the state of the brake pedal 10, resulting in a problem in which the actual necessary braking control may not be performed.

When the notification for inducing zero-point calibration is output through an output device, such as a display and/or speaker, under the control of a vehicle control device, a driver, vehicle inspector, or worker may recognize the matter and perform the zero-point calibration of the pedal displacement sensor PTS to prevent the occurrence of the above-described problem.

For example, the zero-point calibration operation of the pedal displacement sensor PTS may be performed by having an operator move the pedal displacement sensor PTS little by little while simultaneously checking the output signal of the pedal displacement sensor PTS, and fixing the pedal displacement sensor PTS when the output signal is within a specified range.

The controller 110 may include the communication circuitry 111, a memory 113, and/or a processor 115.

For example, the controller 110 may be an electronic control unit (ECU).

The communication circuit 111 may be configured to enable digital communication and/or analog communication.

For example, the communication circuit 111 may communicate data through a communication protocol such as a serial peripheral interface (SIP), an inter-integrated circuit (I2C), a universal asynchronous receiver-transmitter (UART), and/or single edge nibble transmission (SENT).

Additionally, the communication circuit 111 may perform analog communication by including a transmitter, receiver, terminal, wire, and/or connector.

For example, the controller 110 and the pedal displacement sensor PTS may communicate via the SENT communication.

The memory 113 may store or remember a program and data for implementing an operation for controlling the configurations included in the controller 110, that is, implementing an operation for controlling the controller 110.

The identification information of the pedal displacement sensor PTS may be stored in the memory 113.

For example, when manufacturing the brake system 1, the identification information of a pedal displacement sensor PTS may be stored in the memory 113 by the manufacturer.

Additionally, when replacing the pedal displacement sensor PTS, the identification information of the pedal displacement sensor PTS may be stored in the memory 113 by the controller 110.

For example, when it is determined that the pedal displacement sensor PTS has been replaced, the controller 110 may store the identification information of the replaced pedal displacement sensor PTS in the memory 113.

Additionally, the controller 110 may store the identification information of the pedal displacement sensor PTS received from the pedal displacement sensor PTS for each time period in the memory 113.

The memory 113 may provide stored programs and data to the processor 115 and remember temporary data generated during the operation of the processor 115.

For example, the memory 113 may include nonvolatile memory such as a read only memory (ROM), an erasable programmable read only memory (EPROM), or a flash memory.

Additionally, the memory 113 may further include volatile memory such as a static random-access memory (S-RAM) and dynamic random-access memory (D-RAM).

The processor 115 may provide control signals for controlling the operation of components included in the brake system 1.

The brake module 130 is connected to the brake pedal 10 and is mechanically and/or electrically operated and controlled to supply hydraulic pressure of a pressurized medium to a wheel cylinder (not illustrated) provided for each wheel of the vehicle.

For example, although not illustrated, the brake module 130 may include a reservoir (not illustrated) that receives and stores the pressurized medium inside, an integrated master cylinder (not illustrated) that provides a reaction force according to the stepping force of the brake pedal 10 to the driver and pressurizes and discharges the pressurized medium accommodated inside, a hydraulic pressure supply device (not illustrated) that receives the driver’s braking will as an electrical signal from the pedal displacement sensor PTS that detects the displacement of the brake pedal 10 and generates hydraulic pressure of the pressurized medium through mechanical operation, a hydraulic control unit (not illustrated) that controls the hydraulic pressure provided from the hydraulic pressure supply device, a reservoir flow path (not illustrated) that hydraulically connects the reservoir and the integrated master cylinder, a dump control unit (not illustrated) that is provided between the hydraulic pressure supply device and the reservoir and controls the flow of the pressurized medium, and an inspection flow path (not illustrated) that is provided to connect the integrated master cylinder and the hydraulic pressure supply device and inspects for leaks in various component elements.

In addition, for example, although not illustrated, the brake module 130 may include a pair of pad plates (not illustrated) installed to pressurize a brake disc (not illustrated) that rotates with wheels FL, FR, RL, and RR of the vehicle, a caliper housing (not illustrated) that operates the pair of pad plates, a piston (not illustrated) that is installed retractably inside the caliper housing, a power conversion unit (not illustrated) that receives a rotational driving force for moving the piston, converts the received rotational driving force into a linear driving force, and transmits the linear driving force to the piston, and/or a brake motor that generates a rotational driving force for moving the piston.

Meanwhile, in the embodiment of FIG. 1 described above, it is described that there is one controller 110, but according to an additional embodiment, the controller 110 may include a first controller (not illustrated) and a second controller (not illustrated).

Accordingly, one of the first controller and the second controller operates as a main controller to control the brake system 1, and the other thereof operates as a sub-controller to control the brake system 1 when the main controller is inoperable.

In addition, the structure of the brake pedal 10 and the pedal displacement sensor PTS in the embodiment of FIG. 2 described above is one embodiment and may be changed according to the designer.

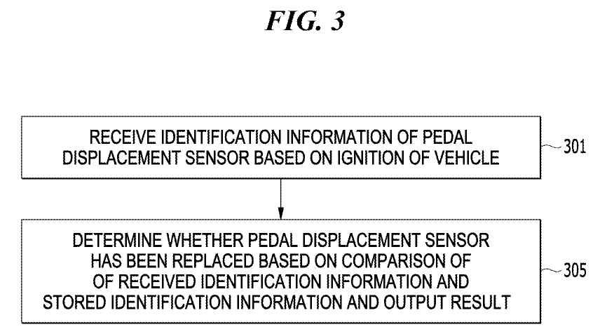

FIG. 3 is a flow chart of the operation of the brake system 1 and/or controller 110 according to one embodiment.

Referring to FIG. 3, the brake system 1 may receive the identification information of the pedal displacement sensor PTS from the pedal displacement sensor PTS based on ignition of the vehicle (301).

The brake system 1 may identify that the vehicle is ignited based on power supply to the brake system 1 and/or reception of the signal from the vehicle control device.

The brake system 1 may receive the identification information of the pedal displacement sensor PTS from the pedal displacement sensor PTS every time the vehicle is ignited.

The brake system 1 may determine whether the pedal displacement sensor PTS has been replaced based on a comparison of the received identification information of the pedal displacement sensor PTS and the identification information of the pedal displacement sensor PTS stored in the memory 113 and output the result (303).

The brake system 1 may determine that the pedal displacement sensor PTS has not been replaced based on the fact that the received identification information of the pedal displacement sensor PTS and the identification information of the pedal displacement sensor PTS stored in the memory 113 are the same.

The brake system 1 may determine that the pedal displacement sensor PTS has been replaced based on the fact that the received identification information of the pedal displacement sensor PTS and the identification information of the pedal displacement sensor PTS stored in the memory 113 are different from each other.

The brake system 1 may additionally verify whether the pedal displacement sensor PTS has actually been replaced or whether it is determined incorrectly due to temporary environmental changes or operation, when the received identification information of the pedal displacement sensor PTS and the identification information of the pedal displacement sensor PTS stored in the memory 113 are different from each other.

For example, the brake system 1 may increase a count value when the identification information received from the pedal displacement sensor PTS in the current time period is different from the identification information stored in the memory 113.

The brake system 1 may compare the first identification information received from the pedal displacement sensor PTS in the current time period with second identification information received in the time period immediately before the current time period based on the increase in the count value.

For example, when the current time period is the first time period in which identification information is received from the pedal displacement sensor PTS after the ignition of the vehicle, the brake system 1 may re-perform operations from the increase of the above-described count value.

The brake system 1 may determine whether the increased count value is greater than a prespecified maximum reference count value by comparing the increased count value with a pre-specified reference count value based on the fact that the first identification information and the second identification information are the same.

The brake system 1 determines that the pedal displacement sensor PTS has been replaced when the increased count value is greater than the pre-specified reference count value, otherwise, the brake system may repeatedly perform the operations described above, starting from receiving identification information from the pedal displacement sensor PTS and comparing the received identification information with the identification information stored in the memory 113.

Meanwhile, the brake system 1 may set the increased count value to 0 based on the difference between the first identification information and the second identification information, and repeatedly perform the operations described above, starting from receiving identification information from the pedal displacement sensor PTS and comparing the received identification information with the identification information stored in the memory 113.

The brake system 1 may determine whether the current time period described above is the first time period in which identification information is received from the pedal displacement sensor PTS after the ignition of the vehicle by comparing the received identification information with the identification information stored in the memory 113 and comparing whether the increased count value is greater than 1.

For example, the brake system 1 may determine that the current time period is not the first time period in which identification information is received from the pedal displacement sensor PTS after the ignition of the vehicle when the increased count value is greater than 1, and otherwise determine that the current time period is the first time period in which identification information is received from the pedal displacement sensor PTS after the ignition of the vehicle.

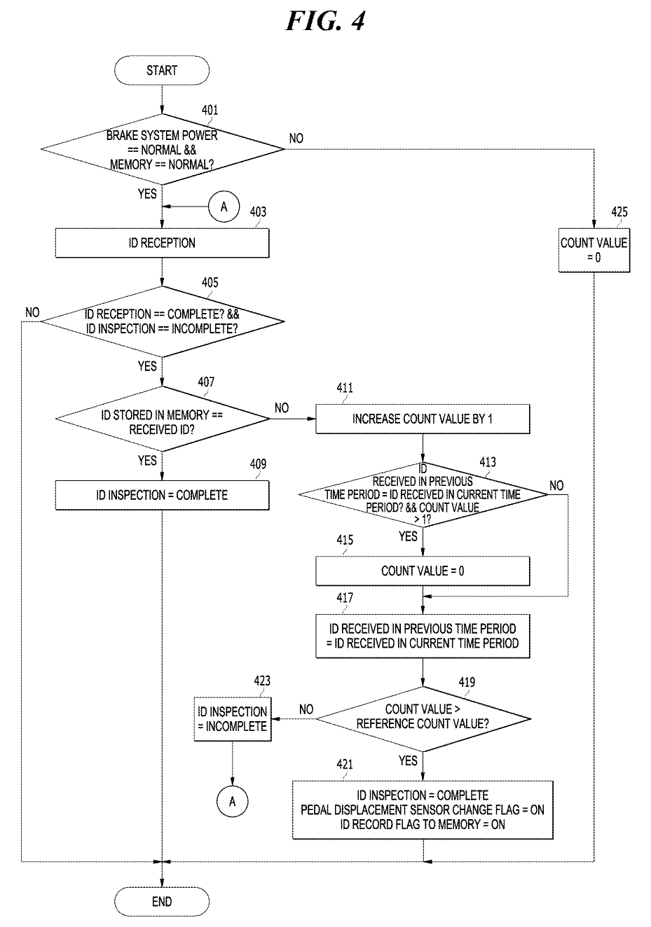

FIG. 4 is a flow chart of the operation of the brake system 1 and/or controller 110 according to one embodiment.

Referring to FIG. 4, the brake system 1 may determine whether the power of the brake system 1 is normal and whether the memory 113 is normal (401).

The brake system 1 may determine whether the power of the brake system 1 is normal and whether the memory 113 is normal based on the ignition of the vehicle.

The brake system 1 may perform an operation 403 when the power of the brake system 1 is normal and the memory 113 is operated normally, and otherwise may perform an operation 425.

The brake system 1 may receive an ID of the pedal displacement sensor PTS from the pedal displacement sensor PTS (403).

The brake system 1 may receive the ID of the pedal displacement sensor PTS from the pedal displacement sensor PTS in response to the power of the brake system 1 being normal and the memory 113 being normal.

The brake system 1 may receive the ID of the pedal displacement sensor PTS from the pedal displacement sensor PTS via the SENT communication.

For example, the brake system 1 may receive the slow channel data including the ID of the pedal displacement sensor PTS from the pedal displacement sensor PTS via the SENT communication, and identify the ID of the pedal displacement sensor PTS received from the pedal displacement sensor PTS based on the slow channel data.

The brake system 1 may determine whether the reception of the ID of the pedal displacement sensor PTS is complete and whether the inspection of the ID of the pedal displacement sensor PTS is incomplete (405).

The brake system 1 may determine whether the inspection of the ID of the pedal displacement sensor PTS is incomplete based on the reception of the ID of the pedal displacement sensor PTS from the pedal displacement sensor PTS.

For example, the brake system 1 may determine that the inspection of the ID of the pedal displacement sensor PTS is incomplete when the ID of the pedal displacement sensor PTS is received from the pedal displacement sensor PTS for the first time after the ignition of the vehicle.

Additionally, the brake system 1 may determine that the inspection of the ID is incomplete in response to an operation 423 described below.

The brake system 1 may perform an operation 407 when the reception of the ID of the pedal displacement sensor PTS is complete and the inspection of the ID of the pedal displacement sensor PTS is incomplete, and otherwise, terminate the operations of the present embodiment.

The brake system 1 may determine whether the ID of the pedal displacement sensor PTS stored in the memory 113 and the ID of the pedal displacement sensor PTS received from the pedal displacement sensor PTS are the same in response to the determination that the reception of the ID of the pedal displacement sensor PTS is complete and the inspection of the ID of the pedal displacement sensor PTS is incomplete (407).

The brake system 1 may perform an operation 409 when the ID of the pedal displacement sensor PTS stored in the memory 113 and the ID of the pedal displacement sensor PTS received from the pedal displacement sensor PTS are the same, and otherwise, perform an operation 411.

The brake system 1 may determine that the inspection of the ID of the pedal displacement sensor PTS is complete in response to that fact that the ID of the pedal displacement sensor PTS stored in the memory 113 is the same as the ID of the pedal displacement sensor PTS received from the pedal displacement sensor PTS (409).

The brake system 1 may increase the count value (IDCheckCount) used for inspecting the ID of the brake pedal displacement sensor PTS by 1 in response to that fact that the ID of the pedal displacement sensor PTS stored in the memory 113 is different from the ID of the pedal displacement sensor PTS received from the pedal displacement sensor PTS (411).

For example, when the brake system 1 compares whether the ID of the pedal displacement sensor PTS stored in the memory 113 and the ID of the pedal displacement sensor PTS received from the pedal displacement sensor PTS are the same for the first time after the ignition of the vehicle, the brake system 1 may increase the count value from 0 to 1.

The count value may be said to be a count value of the number of times additionally verifying whether the determination that the ID of the pedal displacement sensor PTS stored in the memory 113 and the ID of the pedal displacement sensor PTS received from the pedal displacement sensor PTS are different from each other is an erroneous determination due to temporary environmental changes, operations, or the like.

The brake system 1 may, in response to the increase of the count value by 1, determine whether the ID received from the pedal displacement sensor PTS in the previous time period and the ID received from the pedal displacement sensor PTS in the current time period are different from each other and the count value is greater than 1 (413).

The reason why the brake system 1 determines whether the count value is greater than 1 is to whether the determination that the ID of the pedal displacement sensor PTS received from the pedal displacement sensor PTS is different from the ID of the pedal displacement sensor PTS stored in the memory 113 is performed for the first time.

As described later, this is so that, when the determination that the ID of the pedal displacement sensor PTS received from the pedal displacement sensor PTS is different from the ID of the pedal displacement sensor PTS stored in the memory 113 is performed for the first time, the brake system 1 re-performs the operation of comparing the ID of the pedal displacement sensor PTS received through the reception the ID of the pedal displacement sensor PTS from the pedal displacement sensor PTS in the time period immediately following the current time period with the ID stored in the memory 113.

The brake system 1 may perform an operation 415 when the ID received from the pedal displacement sensor PTS in the previous time period is different from the ID received from the pedal displacement sensor PTS in the current time period and the count value is greater than 1, and otherwise, perform an operation 417.

The brake system 1 may determine the count value to be 0 in response to the fact that the ID received from the pedal displacement sensor PTS in the previous time period is different from the ID received from the pedal displacement sensor PTS in the current time period and the count value is greater than 1 (415).

The brake system 1 may store the ID received from the pedal displacement sensor PTS in the current time period as the ID received from the pedal displacement sensor PTS in the previous time period in response to the above-described operation 413 or the above-described operation 415 (417).

The brake system 1 may store the ID received from the pedal displacement sensor PTS in the current time period as the ID received from the pedal displacement sensor PTS in the previous time period in response to determining the count value as 0.

Alternatively, the brake system 1 may store the ID received from the pedal displacement sensor PTS in the current time period as the ID received from the pedal displacement sensor PTS in the previous time period in response to the fact that the ID received from the pedal displacement sensor PTS in the previous time period is the same as the ID received from the pedal displacement sensor PTS in the current time period.

Alternatively, brake system 1 may store the ID received from the pedal displacement sensor PTS in the current time period may be stored as the ID received from the pedal displacement sensor PTS in the previous time period in response to the fact that the count value is less than or equal to 1.

The brake system 1 may determine whether the count value is greater than the pre-specified reference count value in response to storing the ID received from the pedal displacement sensor PTS in the current time period as the ID received from the pedal displacement sensor PTS in the previous time period (419).

The brake system 1 may perform an operation 421 in response to the fact that the count value being greater than the pre-specified reference count value, and otherwise, perform an operation 423.

The brake system 1 may determine that the inspection of the ID of the pedal displacement sensor PTS is complete in response to the fact that the count value is greater than the pre-specified reference count value, turn on a change flag of the pedal displacement sensor PTS, and turn on an ID record flag of the pedal displacement sensor PTS to the memory 113 (421).

The brake system 1 may determine that the pedal displacement sensor PTS has been replaced according to ON of the change flag of the pedal displacement sensor PTS.

The brake system 1 may update and newly store the ID of the pedal displacement sensor PTS received from the pedal displacement sensor PTS in the current time period in the memory 113 according to ON of the ID record flag of the pedal displacement sensor PTS to the memory 113.

The brake system 1 may determine that the inspection of the ID of the pedal displacement sensor PTS is incomplete in response to the fact that the count value is less than or equal to the pre-specified reference count value (423).

The brake system 1 may perform the above-described operation 403 again in response to the determination that the ID of the pedal displacement sensor PTS is incomplete.

Meanwhile, the brake system 1 may terminate the operation of the present embodiment after determining the count value as 0 in response to the above-described operation 401.

In addition to the above-described embodiment, when the brake system 1 determines that the pedal displacement sensor PTS has been replaced, the brake system 1 may determine that a failure due to the replacement of the pedal displacement sensor PTS has been detected.

Additionally, the brake system 1 may transmit a signal indicating the occurrence of an error to the vehicle control device in response to the fact that the failure due to the replacement of the pedal displacement sensor PTS has been detected.

Alternatively, when the brake system 1 determines that the pedal displacement sensor PTS has been replaced, the brake system 1 may delete a zero-point calibration value of the pedal displacement sensor PTS stored in the memory 113 and determine that a failure due to the absence of the zero-point calibration value of the pedal displacement sensor PTS has been detected.

Additionally, the brake system 1 may transmit the signal indicating the error occurrence to the vehicle control device in response to the detection of the failure due to the absence of the zero-point calibration value of the pedal displacement sensor PTS.

In addition to the embodiments described above, the brake system 1 may transmit a control signal to the vehicle control device so that, in response to the determination that the pedal displacement sensor PTS has been replaced, the notification is output to the output device of the vehicle to induce zero-point calibration of the pedal displacement sensor PTS.

Accordingly, the vehicle control device that receives the notification from the brake system 1 may output the notification that induces the zero-point of the pedal displacement sensor PTS through the output device of the vehicle, such as a display and/or speaker, so that the driver or vehicle inspector may be aware of the matter.

Meanwhile, in the above-described embodiment, it is described that the ID stored in the memory 113 is compared based on the ID reception of the pedal displacement sensor PTS, but in addition to the ID, it may be replaced with a serial number or the like indicating identification information of the pedal displacement sensor PTS.

In addition, the embodiment of FIG. 3 described above may further increase the reliability of the determination of whether the pedal displacement sensor PTS has been replaced by additionally verifying whether the pedal displacement sensor PTS has actually been replaced or whether it is determined incorrectly due to temporary environmental changes or operations, when the ID received from the pedal displacement sensor PTS and the ID stored in the memory 113 are different from each other.

The brake system 1 and the method for managing the pedal displacement sensor PTS of the brake system 1 according to the above-described embodiments may provide a technology for detecting and managing replacement of the pedal displacement sensor PTS for the brake pedal 10.

In addition, the brake system 1 and the method for managing the pedal displacement sensor PTS of the brake system 1 may provide a technology capable of detecting the replacement of the pedal displacement sensor PTS for the brake pedal 10 and inducing the zero-point calibration of the pedal displacement sensor PTS.

In addition, the brake system 1 and the method for managing the pedal displacement sensor PTS of the brake system 1 may eliminate the tolerance management process of the external pedal displacement sensor, thereby reducing the manufacturing cost.

In addition, the brake system 1 and the method for managing the pedal displacement sensor PTS of the brake system 1 may reduce the maintenance costs by replacing only the pedal displacement sensor PTS unit instead of replacing the assembly including the conventional pedal displacement sensor when the pedal displacement sensor PTS fails.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term 'non-transitory' simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

1. A brake system comprising:
a pedal displacement sensor configured to detect displacement of a brake pedal;
a memory configured to store identification information of the pedal displacement sensor; and
a controller electrically connected to the pedal displacement sensor and the memory,
wherein the controller is configured to
receive identification information of the pedal displacement sensor from the pedal displacement sensor based on ignition of a vehicle, and
determine whether the pedal displacement sensor has been replaced based on comparison of the received identification information and the stored identification information.

2. The brake system of claim 1, wherein the controller is configured to determine that the pedal displacement sensor has been replaced when the received identification information and the stored identification information are different from each other.

3. The brake system of claim 2, wherein the controller is configured to
increase a count value when first identification information received from the pedal displacement sensor in a current time period and the stored identification information are different from each other, and
determine that the pedal displacement sensor has been replaced based on the increased count value being greater than a pre-specified reference count value.

4. The brake system of claim 3, wherein the controller is configured to
compare the first identification information with second identification information received from the pedal displacement sensor in a time period immediately preceding the current time period, based on an increase in the count value, and
determine whether the increased count value is greater than the pre-specified reference count value, based on the first identification information and the second identification information are the same.

5. The brake system of claim 4, wherein the controller is configured to set the increased count value to 0 based on the first identification information and the second identification information being different from each other and the increased count value being greater than 1, and receive identification information from the pedal displacement sensor.

6. The brake system of claim 2, wherein the controller is configured to store the received identification information in the memory as the identification information of the pedal displacement sensor, based on the determination that the pedal displacement sensor has been replaced.

7. The brake system of claim 2, wherein the controller is configured to transmit a control signal to a control device of the vehicle so that, based on the determination that the pedal displacement sensor has been replaced, a notification is output to an output device of the vehicle to induce zero-point calibration of the pedal displacement sensor.

8. The brake system of claim 1, wherein the controller is configured to determine that the pedal displacement sensor is not replaced when the received identification information and the identification information stored in the memory are the same.

9. The brake system of claim 1, wherein the controller is configured to receive the identification information of the pedal displacement sensor from the pedal displacement sensor through single edge nibble transmission (SENT) communication.

10. The brake system of claim 9, wherein the controller is configured to receive slow channel data including the identification information of the pedal displacement sensor from the pedal displacement sensor through the SENT communication.

11. A method for managing a pedal displacement sensor of a brake system, the method comprising:
receiving identification information of a pedal displacement sensor from the pedal displacement sensor that detects displacement of a brake pedal of a vehicle based on ignition of the vehicle; and
determining whether the pedal displacement sensor has been replaced based on comparison of the received identification information and identification information stored in a memory.

12. The method of claim 11, wherein the determining of whether the pedal displacement sensor has been replaced includes determining that the pedal displacement sensor has been replaced when the received identification information and the stored identification information are different from each other.

13. The method of claim 12, wherein the determining of whether the pedal displacement sensor has been replaced includes
increasing a count value when first identification information received from the pedal displacement sensor in a current time period and the stored identification information are different from each other, and
determining that the pedal displacement sensor has been replaced based on the increased count value being greater than a predetermined reference count value.

14. The method of claim 13, wherein the determining of whether the pedal displacement sensor has been replaced includes
comparing the first identification information with second identification information received from the pedal displacement sensor in a time period immediately preceding the current time period, based on an increase in the count value, and
determining whether the increased count value is greater than the pre-specified reference count value, based on the first identification information and the second identification information being the same.

15. The method of claim 14, wherein the determining of whether the pedal displacement sensor has been replaced includes setting the increased count value to 0 based on the first identification information and the second identification information being different from each other and the increased count value being greater than 1, and receiving identification information from the pedal displacement sensor.

16. The method of claim 12, further comprising storing the received identification information in the memory as the identification information of the pedal displacement sensor, based on the determination that the pedal displacement sensor has been replaced.

17. The method of claim 12, further comprising transmitting a control signal to a control device of the vehicle so that, based on the determination that the pedal displacement sensor has been replaced, a notification is output to an output device of the vehicle to induce zero-point calibration of the pedal displacement sensor.

18. The method of claim 11, wherein the determining of whether the pedal displacement sensor has been replaced includes determining that the pedal displacement sensor is not replaced when the received identification information and the identification information stored in the memory are the same.

19. The method of claim 11, wherein the receiving of the identification information of the pedal displacement sensor includes receiving the identification information of the pedal displacement sensor from the pedal displacement sensor through single edge nibble transmission (SENT) communication.

20. The method of claim 19, wherein the receiving of the identification information of the pedal displacement sensor includes receiving slow channel data including the identification information of the pedal displacement sensor from the pedal displacement sensor through the SENT communication.
